(19) United States
(12) Patent Application Publication
(10) Pub. No.: US 2024/0233555 A1
(43) Pub. Date: Jul. 11, 2024

(54) TREE-SEARCH BASED TRAJECTORY PLANNING AND RESOURCE MANAGEMENT METHOD AND APPARATUS OF UNMANNED AERIAL VEHICLE BASE STATION

(71) Applicant: POSTECH RESEARCH AND BUSINESS DEVELOPMENT FOUNDATION, Pohang-si (KR)

(72) Inventors: Hyeon Su LYU, Pohang-si (KR); Hyun Jong YANG, Pohang-si (KR); Jong Gyu JANG, Pohang-si (KR)

(73) Assignee: POSTECH RESEARCH AND BUSINESS DEVELOPMENT FOUNDATION, Pohang-si (KR)

(21) Appl. No.: 18/319,369

(22) Filed: May 17, 2023

(30) Foreign Application Priority Data
Dec. 27, 2022 (KR) 10-2022-0186323

(51) Int. Cl. G08G 5/00

(52) U.S. Cl. CPC G08G 5/003; G08G 5/0069

(57) ABSTRACT

The present disclosure relates to a tree-search based trajectory planning and resource management method and apparatus of an unmanned aerial vehicle base station. The tree-search based trajectory planning and resource management method of an unmanned aerial vehicle base station according to an embodiment of the present disclosure includes: decomposing an optimization problem of trajectory planning, user association (UA), resource allocation (RA), and power control (PC) related to the unmanned aerial vehicle base station into a time axis; managing resources by jointly optimizing variables of the UA, RA, and PC for an arbitrary location of the unmanned aerial vehicle base station; and obtaining the trajectory planning by obtaining position variables based on the obtained predetermined function value and a depth-first search (DFS) algorithm.

### CROSS-REFERENCE TO RELATED APPLICATIONS

This application claims benefit of priority to Korean Patent Application No. 10-2022-0186323 filed on 27 Dec. 2022 in the Korean Intellectual Property Office, the disclosure of which is incorporated herein by reference in its entirety.

### TECHNICAL FIELD

The present disclosure relates to a tree-search based trajectory planning and resource management method and apparatus of an unmanned aerial vehicle base station.

### BACKGROUND

The related art is a technique that maximizes proportional fairness (PF) approximated by a weighted sum-rate in the presence of an unmanned aerial vehicle (UAV) relay base station assisting a ground base station. In particular, the related art provides a technique in which a user selects a base station to be connected to between a ground base station and a UAV relay base station, and allocates frequency resources and transmission power according to user connection. The solution of the user connection method was settled by searching for a user connection combination for a given location and frequency/power using a random search algorithm called a matching game. For a given user association variable, the optimal location, frequency allocation, and power control of a drone base station were all obtained using a program that searches for a solution to a convex optimization problem.

Specifically, each control variable is optimized through a convex optimization solver such as CVX while other control variables are fixed. For example, frequency allocation is performed by fixing the location of the UAV relay base station, user connection, and power control variables to specific values, and finding an optimal frequency allocation variable for the given control variables. When the user association variables are obtained through the matching game, the aforementioned optimization methods are sequentially used in the order of location, frequency allocation, and power control of a base station to optimize the location, frequency, and power variables, and the optimal control variable is found by repetition several times.

The optimization is performed every unit time, and by repeated performance, a service method for the entire service time may be completed.

Upon reviewing the issues of the related art, first, since the related art has a large amount of computation of matching games and convex optimization solvers, it takes a lot of time to plan a route of a UAV relay base station when many users are being served.

Second, the PF approximated by the weighted sum-rate has no choice but to serve a mathematically small number of users, which is not a suitable method as a control goal of a UAV base station that provides short-term communication service due to limited battery capacity.

Third, when a trajectory optimization problem with large nonlinearity of an objective function is addressed using the method used in the related art, it is impossible to update a randomly selected initial trajectory to an optimal trajectory far away.

Fourth, there is a possibility that optimal user association variables may not be found when the user association is optimized for randomly set frequency allocation variables and power control variables. For example, it is assumed that user A is closer to a UAV relay base station so that it is better to receive a communication service from the UAV relay base station than to communicate with a ground base station. However, when the UAV relay base station allocates few frequency resources to user A, user A may misjudge that it is better to connect to the ground base station and have an incorrect combination of user association variables.

Fifth, a user does not always ask for a communication service, but requests a communication service only when data communication is needed, but this feature is not taken into account.

Sixth, obtaining a trajectory of a UAV base station by optimizing the location every time does not guarantee a good trajectory. For example, it is assumed that a user located east of the UAV base station requests a small amount of data communication at the current time, and a group of users located west thereof requests a large amount of data communication in the future. Then, the UAV base station moves eastward because it is advantageous to move eastward in the short term, which may fail to accommodate a large amount of data communication services occurring in the west. Accordingly, trajectory planning considering hourly user demand is required, which may not be addressed by optimizing the location of the UAV base station for every unit time.

### SUMMARY

Recent advances in UAV base stations (UAV-BSs) have led to a proliferation of studies on wireless technologies for IoT networks. In the IoT networks, the UAV-BSs may utilize mobility to provide high-speed access links to widespread IoT devices.

Embodiments of the present disclosure are directed to providing a tree-search based trajectory planning and resource management method and apparatus of an unmanned aerial vehicle base station for maximizing the proportional fairness (PF) under users' communication requests and quality-of-service (QOS) constraints by optimizing trajectory planning, user association (UA), resource allocation (RA), and power control (PC).

However, the aspects of the present disclosure are not limited thereto, and may be variously expanded in an environment within a range not departing from the idea and the scope of the present disclosure.

According to an embodiment of the present disclosure, there may be provided a tree-search based trajectory planning and resource management method of an unmanned aerial vehicle base station performed by a trajectory planning and resource management apparatus, wherein the method includes: decomposing an optimization problem of trajectory planning, user association (UA), resource allocation (RA), and power control (PC) related to the unmanned aerial vehicle base station into a time axis; managing resources by jointly optimizing variables of the UA, RA, and PC for an arbitrary location of the unmanned aerial vehicle base station and computing a predetermined objective function value; and obtaining the trajectory planning by obtaining position variables based on the computed predetermined function value and a depth-first search (DFS) algorithm.

In the decomposition of the optimization problem into the time axis, the optimization problem may be reconstructed into a plurality of sub-problems through a 1-step lookahead and an n-step lookahead.

In the decomposition of the optimization problem into the time axis, a trajectory planning problem and a resource optimization problem may be separated using a predetermined objective function.

In the management of the resources, when position variables and power control variables are given, user association variables and frequency allocation variables may be optimized.

In the management of the resources, optimal user association variables and frequency allocation variables may be selected using a generalized water-filling technique with quality-of-service (QOS) constraints that jointly optimize the user association variables and the frequency allocation variables.

In the management of the resources, when the position variables, the user association variables, and the power control variables are given, the frequency allocation variables may be optimized.

In the management of the resources, after being converted into a Lagrangian dual problem, optimal Lagrangian coefficients may be obtained using a gradient descent technique, and frequency allocation variables may be selected by combination of the obtained Lagrangian coefficients.

In the management of the resources, when the position variables, the user association variables, and the frequency allocation variables are given, the power control variables may be optimized.

In the management of the resources, after being converted into a Lagrangian dual problem, the Lagrangian coefficients that satisfy a Karush-Kuhn-Tucker (KKT) conditions may be obtained, and power control variables having the highest predetermined objective function value among the Lagrangian coefficients satisfying the KKT conditions may be selected.

According to another embodiment of the present disclosure, there may be provided a tree-search based trajectory planning and resource management apparatus of an unmanned aerial vehicle base station, wherein the apparatus includes: a communication module; a memory storing one or more programs; and a processor executing the stored one or more programs, the processor being configured to: decompose an optimization problem of trajectory planning, user association (UA), resource allocation (RA), and power control (PC) related to the unmanned aerial vehicle base station into a time axis; manage resources by jointly optimizing variables of the UA, RA, and PC for an arbitrary location of the unmanned aerial vehicle base station and computing a predetermined objective function value; and obtain the trajectory planning by obtaining position variables based on the computed predetermined function value and a depth-first search (DFS) algorithm.

The processor may reconstruct the optimization problem into a plurality of sub-problems through a 1-step lookahead and an n-step lookahead.

The processor may separate a trajectory planning problem and a resource optimization problem using a predetermined objective function.

When position variables and power control variables are given, the processor may optimize user association variables and frequency allocation variables.

The processor may select optimal user association variables and frequency allocation variables using a generalized water-filling technique with quality-of-service (QOS) constraints that jointly optimize the user association variables and the frequency allocation variables.

When the position variables, the user association variables, and the power control variables are given, the processor may optimize the frequency allocation variable.

After being converted into a Lagrangian dual problem, the processor may obtain optimal Lagrangian coefficients using a gradient descent technique, and select frequency allocation variables by combination of the obtained Lagrangian coefficient.

When the position variables, the user association variables, and the frequency allocation variables are given, the processor may optimize the power control variable.

After being converted into a Lagrangian dual problem, the processor may obtain a Lagrangian coefficients that satisfy Karush-Kuhn-Tucker (KKT) conditions, and select power control variables having the highest predetermined objective function value among the Lagrangian coefficients satisfying the KKT conditions.

The disclosed technology may have following benefits. It should be understood, however, that the scope of right of the disclosed technology is not to be construed as limited thereto, as it is not meant that particular embodiments should include all of the following benefits or only include the following benefits.

Embodiments of the present disclosure may optimize trajectory planning, UA, RA, and PC variables in order to maximize the PF under users' communication requests and quality-of-service (QOS) constraints.

Embodiments of the present disclosure may address resource and trajectory planning for UAV base stations servicing IoT devices with data rate QoS.

Embodiments of the present disclosure may address an issue that the number of related variables exponentially increases with the length of the flight time of a UAV base station, resulting in a significant increase in computational complexity, using a time axis division method.

Embodiments of the present disclosure enable planned trajectory and resource optimization to match the computational ability of a drone base station regardless of flight time, and thus may be suitable for drone base stations with a computer with low computational ability.

### BRIEF DESCRIPTION OF THE DRAWINGS

FIG. 1 is a diagram illustrating a scenario conceptual diagram of a tree-search based trajectory planning and resource management system model of an unmanned aerial vehicle base station, according to an embodiment of the present disclosure.

FIG. 2 is a diagram illustrating Appendix A used in an embodiment of the present disclosure.

FIG. 3 is a schematic diagram illustrating an overall algorithm according to an embodiment of the present disclosure.

FIG. 4 is a flow diagram illustrating a tree-search based trajectory planning and resource management method of an unmanned aerial vehicle base station according to an embodiment of the present disclosure.

FIG. 5 is a diagram illustrating a relationship between ƒ(·) and g(·).

FIG. 6 is a diagram illustrating algorithm 1 according to an embodiment of the present disclosure.

FIG. 7 is a diagram illustrating resource optimization algorithm 2 according to an embodiment of the present disclosure.

FIGS. 8 to 10 are drawings illustrating algorithms 3 to 5 according to an embodiment of the present disclosure.

FIG. 11 is a table illustrating a parameter configuration table set in an embodiment.

FIG. 12A to FIG. 12C are graphs measuring proportional fairness for various QoS constraints according to Embodiment 1.

FIG. 13A to FIG. 13C are graphs measuring a user ratio served for various QoS constraints according to Embodiment 2.

FIG. 14A to FIG. 14C are graphs measuring proportional fairness (PF) for various QoS constraints according to Embodiment 3.

FIG. 15 is a table illustrating a normalized proportional fairness and complexity table according to Embodiment 4.

FIG. 16A to FIG. 16C are graphs illustrating a substantial trajectory of a UAV base station according to a lookahead variable according to Embodiment 5.

FIG. 17 is a block diagram of a tree-search based trajectory planning and resource management apparatus of an unmanned aerial vehicle base station according to an embodiment of the present disclosure.

### DETAILED DESCRIPTION

The present disclosure may be modified in various forms, and specific embodiments thereof will be illustrated in the drawings and described in detail in the detailed description. However, this is not intended to limit the present disclosure to specific embodiments, and it should be understood that all modifications, equivalents and substitutes included in the spirit and technical scope of the present disclosure are included. In describing the present disclosure, when it is determined that a detailed description of a related known technology may obscure the gist of the present disclosure, the detailed description thereof will be omitted.

Terms such as “first” and “second” may be used to describe various components, but the components are not restricted by the terms. The terms are used only to distinguish one component from another component.

The terms used herein are merely used to describe specific embodiments and are not intended to limit the present disclosure. Although the terms used in the present disclosure are selected from generally known and used terms while considering functions of the present disclosure, they may vary according to intention or customs of those skilled in the art or emergence of new technology. Some of the terms mentioned in the description of the present disclosure may have been selected by the applicant at his or her discretion, and in such cases the detailed meanings thereof will be described in relevant parts of the description herein. Thus, the terms used in this specification should be interpreted based on the substantial meanings of the terms and the whole content of this specification rather than their simple names or meanings.

The terms in singular form may include plural forms unless otherwise specified. It will be understood that the terms “comprising” or “having,” when used herein, specify the presence of stated features, integers, steps, operations, elements, components, or combinations thereof, but do not preclude the presence or addition of one or more other features, integers, steps, operations, elements, components, and/or combinations thereof.

Hereinafter, reference will now be made in detail to the embodiments of the present disclosure with reference to the accompanying drawings. Wherever possible, the same reference numbers will be used throughout the disclosure including the drawings to refer to the same or like parts. As such, the repeatable description of the same or like parts will be omitted.

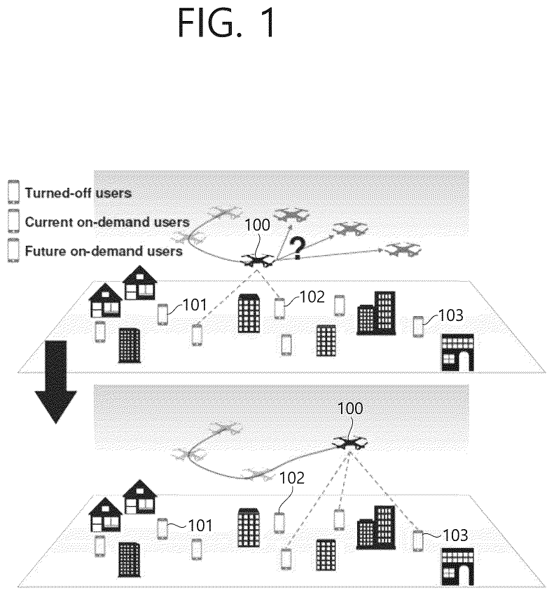

FIG. 1 is a diagram illustrating a scenario conceptual diagram of a tree-search based trajectory planning and resource management system model of an unmanned aerial vehicle base station, according to an embodiment of the present disclosure.

As illustrated in FIG. 1, an unmanned aerial vehicle base station 100 may provide services to IoT devices on the ground. The IoT devices may include turned-off users 101, current on-demand users 102, and future on-demand users 103. The unmanned aerial vehicle base station 100 providing services to the current on-demand users 102 may perform optimal trajectory planning and resource management to provide services to the future on-demand users 103 according to an embodiment of the present disclosure.

First, before describing an embodiment of the present disclosure, a scenario description and variables will be defined.

In an embodiment of the present disclosure, it is assumed that an IoT network in which a single UAV base station serves an l number of IoT devices during a T number of unit time. The UAV base station aims to maximize proportional fairness (PF) of a service user (IoT device) within an available frequency band B (Hz) and transmission power P (dBm). Each user has a time interval for requesting a service, and each user requires a transmission speed (data rate) of a certain level or higher for quality of service. The users are indexed by an index set J={1, . . . , I}.

It is assumed that the UAV base station discretizes a service area and service timeline. In other words, the service timeline is indexed by an index set T={1, . . . , T}, each time slot has the duration of ΔT.

In addition, the UAV base station provides a service to a square-shaped cell with a side length of w. The airspace in which the UAV base station may fly is discretized in the form of a grid having an interval of ΔQ as shown in Equation 1 below:

$$Q = \{ Δ {Q [ i , j , k ]}^{T} \vert {[ i , j , k ]}^{T} ∈ {ℕ}^{3} , i , j ∈ [ 0 , \frac{w}{Δ Q} ] , k ∈ [ \frac{{h}_{m i n}}{Δ Q} , \frac{{h}_{m ax}}{Δ Q} ] \} \qquad [ Equation 1 ]$$

where hₘᵢₙ and hₘₐₓ are the minimum and maximum altitude of the UAV base station, respectively.

When the t-th time slot begins, the UAV base station should be located on a grid point. When q^{(t)} is defined as a location of the UAV base station at time slot t, q^{(t)} satisfies Equation 2 below:

$$\begin{matrix}[ Equation 2 ] & \\ {q}^{( t )} = {[ {x}^{( t )} , {y}^{( t )} , {h}^{( t )} ]}^{T} ∈ Q & \end{matrix}$$

Additionally, q⁽⁰⁾ is expressed as a location of the UAV base station when the service begins. Since the UAV base station has an inherent maximum speed, the relational expression as in Equation 3 below holds for all time slots:

$$\begin{matrix}[ Equation 3 ] & \\ ‖ {q}^{( t )} - {q}^{( t - 1 )} ‖ \leq v Δ T , ∀ t ∈ 𝒯 & \end{matrix}$$

From a user's point of view, a system model according to an embodiment of the present disclosure is described as follows. The i-th user is located at qᵢ=[xᵢ, yᵢ, 0]^{T}, and each user exists in an interval [sᵢ, sᵢ+Tᵢ] requesting a service. A binary indicator dᵢ^{(t)} indicating whether the i-th user requests a service at the t-th time slot is defined as in Equation 4 below:

$$\begin{matrix}[ Equation 4 ] & \\ {d}_{i}^{( t )} = \{ \begin{matrix}1 , & if {s}_{i} \leq t \leq {s}_{i} + {T}_{i} \\ 0 , & otherwise\end{matrix} . & \end{matrix}$$

The UAV base station (UAV-BS) selects a plurality of users every time slot to provide a service. Accordingly, a user association (UA variables αᵢ^{(t)}) is defined as in Equation 5 below:

$$\begin{matrix}[ Equation 5 ] & \\ {α}_{i}^{( t )} = \{ \begin{matrix}1 , & i f the UAV - BS serves user i at time slot t \\ 0 , & otherwise\end{matrix} . & \end{matrix}$$

In addition, the frequency band that the user i receives from the time slot t is denoted as βᵢ^{(t)}. The summation of the frequency band of each user should not exceed the available frequency bandwidth B for each time slot, and this may be expressed as in Equation 6 below:

$$\begin{matrix}[ Equation 6 ] & \\ {\sum }_{i ∈ {α}^{( t )}} {β}_{i}^{( t )} \leq B , ∀ t ∈ 𝒯 , & \end{matrix}$$

where the set α^{(t)}={i∈J|αᵢ^{(t)}=1} denotes a set of user indices served by the UAV base station at time slot t.

The UAV base station regulates its transmission power by adjusting the power spectral density (PSD). The variables ρᵢ^{(t)} is defined as the assigned PSD to the i-th user at time slot t. Denoting the maximum transmission power of the UAV base station as P, the transmission power should satisfy the condition of Equation 7 below:

$$\begin{matrix}[ Equation 7 ] & \\ {\sum }_{i ∈ {α}^{( t )}} {ρ}_{i}^{( t )} {β}_{i}^{( t )} \leq P , ∀ t ∈ 𝒯 , & \end{matrix}$$

Next, pathloss and a data rate model will be described.

The transmission channel between the UAV base station and a user follows a probabilistic line of sight (LoS) channel model. The probability that the UAV base station and the ground user have an LoS channel may be expressed as Equation 8 below.

$$\begin{matrix}[ Equation 8 ] & \\ {P}_{i}^{( t )} = \frac{1}{1 + a \cdot exp ( - b ( {θ}_{i}^{( t )} - a ) )} , & \end{matrix}$$

where

$${θ}_{i}^{( t )} = arcsin ( \frac{{h}^{( t )}}{{‖ {q}^{( t )} - {q}_{i} ‖}_{2}} )$$

is the angle between the UAV base station and the i-th user. In addition, environmental variables a and b vary according to the surrounding environmental characteristics. In this connection, the average pathloss for the i-th user at time slot t may be expressed as in Equation 9 below:

$$\begin{matrix}[ Equation 9 ] & \\ {ξ}_{i}^{( t )} = 20 log ( \frac{4 π f {‖ {q}^{( t )} - {q}_{i} ‖}_{2}}{c} ) + {P}_{i}^{( t )} {η}_{LoS} + ( 1 - {P}_{i}^{( t )} ) {η}_{Nlos} , & \end{matrix}$$

where ƒ and c denote the carrier frequency, and the speed of light, respectively.

Finally, the data rate of the i-th user at time slot t is defined as Equation 10 below:

$$\begin{matrix}[ Equation 10 ] & \\ {R}_{i}^{( t )} = {d}_{i}^{( t )} {β}_{i}^{( t )} {log}_{2} ( 1 + \frac{{ρ}_{i}^{( t )} {10}^{- {ξ}_{i}^{( t )} / 10}}{{N}_{0}} ) , & \end{matrix}$$

where N₀ denotes noise power spectral density.

To ensure the users' QoS requirements, the UAV base station should serve user i with a link that has a data rate higher than rᵢ. This may be expressed as Equation 11 below:

$$\begin{matrix}[ Equation 11 ] & \\ {R}_{i}^{( t )} \geq {α}_{i}^{( t )} {r}_{i} . & \end{matrix}$$

Finally, the sum-data rate of the i-th user across the UAV base station service timeline is expressed as in Equation 12 below:

$$\begin{matrix}[ Equation 12 ] & \\ {R}_{i} = {\sum }_{t ∈ 𝒯} {R}_{i}^{( t )} . & \end{matrix}$$

Based on Rᵢ, the PF of the entire network is defined as Σ_{i∈α} log Rᵢ.

The setting of an optimization problem according to an embodiment of the present disclosure will be described.

Based on the system model set above, the trajectory planning, user association (UA), resource allocation (RA), and power control (PC) problems are constructed as shown in Equation 13 below:

$$\begin{matrix}[ Equation 13 ] & \\ P 1 : {max}_{q , α , β , ρ} {\sum }_{i ∈ α} log {R}_{i} & ( 13 a )\end{matrix}$$

$$s . t . {q}^{( t )} ∈ Q , \qquad ( 13 b )$$

$${‖ {q}^{( t )} - {q}^{( t - 1 )} ‖}_{2} \leq r Δ T , \qquad ( 13 c )$$

$${β}_{i}^{( t )} \geq 0 , ∀ i ∈ \text{?} , \qquad ( 13 d )$$

$${\sum }_{i ∈ α} \text{?} {β}_{i}^{( t )} \leq β , \qquad ( 13 e )$$

$${ρ}_{i}^{( t )} \geq 0 , ∀ i ∈ \text{?} , \qquad ( 13 f )$$

$${\sum }_{i ∈ α} \text{?} {ρ}_{i}^{( t )} {β}_{i}^{( t )} \leq P , \qquad ( 13 g )$$

$${R}_{i}^{( i )} \geq {α}_{i}^{( t )} {r}_{i} , ∀ i ∈ \text{?} , \qquad ( 13 h )$$

$$∀ t ∈ 𝒯 for ( 13 b ) - ( 13 h ) .$$

$$\text{?} \text{indicates text missing or illegible when filed}$$

For brevity of the equations,

$$q = {[ {q}^{( t )} ]}^{t ∈ 𝒯} , β = {[ {β}_{i}^{( t )} ]}_{i ∈ 𝒥}^{t ∈ 𝒯} , ρ = {[ {ρ}_{i}^{( t )} ]}_{i ∈ 𝒥}^{t ∈ 𝒯} , and \\ α = {⋃}_{t ∈ 𝒯} {α}^{( t )} .$$

The problem with Equation 13 is a non-convex mixed-integer problem that is known to be NP-hard, and is a complex problem that requires all optimization of numerous time slots. Hence, it is difficult to be solved by conventional methods. Accordingly, in an embodiment of the present disclosure, the problem of Equation 13 is reconstructed into several mathematically well-defined sub-problems to solve the problem.

The 1-step lookahead problem will be described. In an embodiment of the present disclosure, the problem of Equation 13 may be reconstructed into a T number of sub-problems using a proposition such as Equation 14 below.

$$\begin{matrix}[ Equation 14 ] & \\ Proposition 1 ( Lower bound of Problem P 1 ) . & ( 14 )\end{matrix}$$

$$The following inequality h olds : {max}_{q , α , β , ρ} {\sum }_{i ∈ α} log {R}_{i} \geq {\sum }_{t = 1}^{T} {max}_{{q}^{( t )} , {α}^{( t )} , {β}^{( t )} , {ρ}^{( t )}} {\sum }_{i ∈ α \text{?}} log ( 1 + \frac{{R}_{i}^{( t )}}{{\sum }_{i = 0}^{t - 1} {R}_{i}^{( k )}} ) .$$

$$Proof : The proof is shown in Appendix A .$$

$$\text{?} \text{indicates text missing or illegible when filed}$$

Using the above, P^{(t)} may be defined as in Equation 15 below:

$$\begin{matrix}[ Equation 15 ] & \\ {P}^{( t )} : {max}_{{q}^{( t )} , {α}^{( t )} , {β}^{( t )} , {ρ}^{( t )}} {\sum }_{i ∈ {α}^{( t )}} log ( 1 + \frac{{R}_{i}^{( t )}}{{\sum }_{k = 0}^{t - 1} {R}_{i}^{( k )}} ) , & ( 15 a )\end{matrix}$$

$$s . t . ( 13 b ) - ( 13 h ) , \qquad ( 15 b )$$

where

$${β}^{( t )} = {[ {β}_{i}^{( t )} ]}_{i ∈ 𝒥} , and {ρ}^{( t )} = {[ {ρ}_{i}^{( t )} ]}_{i ∈ 𝒥} .$$

In an embodiment of the present disclosure, in order to relax the non-convexity of P^{(t)}, P^{(t)} is separated into the problems of solving q^{(t)} and α^{(t)}, β^{(t)}, ρ^{(t)}. For brevity of the notations, the spanning function S(·) is defined as in Equation 16 below:

$$\begin{matrix}[ Equation 16 ] & \\ S ( q ) = \{ {q}^{′} ∈ Q \vert {‖ {q}^{′} - q ‖}_{2} \leq v Δ T \} . & \end{matrix}$$

Then, P^{(t)} may be expressed as in Equation 17 below:

$$\begin{matrix}[ Equation 17 ] & \\ {max}_{{q}^{( t )} ∈ 𝒮 ( {q}^{( t - 1 )} )} f ( {q}^{( t )} ) , & ( 17 )\end{matrix}$$

$$where f ( {q}^{( t )} ) is defined as$$

$$f ( {q}^{( t )} ) = {max}_{{α}^{( t )} , {β}^{( t )} , {ρ}^{( t )}} {\sum }_{i ∈ {α}^{( t )}} log ( 1 + \frac{{R}_{i}^{( t )}}{{\sum }_{t = 0}^{t - 1} {R}_{i}^{( k )}} ) \qquad ( 18 a )$$

$$s . t . ( 13 d ) - ( 13 h ) . \qquad ( 18 b )$$

where ƒ(q^{(t)}) is represented as Equation 18 below:

$$\begin{matrix}[ Equation 18 ] & \\ {max}_{{q}^{( t )} ∈ 𝒮 ( {q}^{( t - 1 )} )} f ( {q}^{( t )} ) , & ( 17 )\end{matrix}$$

$$where f ( {q}^{( t )} ) is defined as$$

$$f ( {q}^{( t )} ) = {max}_{{α}^{( t )} , {β}^{( t )} , {ρ}^{( t )}} {\sum }_{i ∈ {α}^{( t )}} log ( 1 + \frac{{R}_{i}^{( t )}}{{\sum }_{t = 0}^{t - 1} {R}_{i}^{( k )}} ) \qquad ( 18 a )$$

$$s . t . ( 13 d ) - ( 13 h ) . \qquad ( 18 b )$$

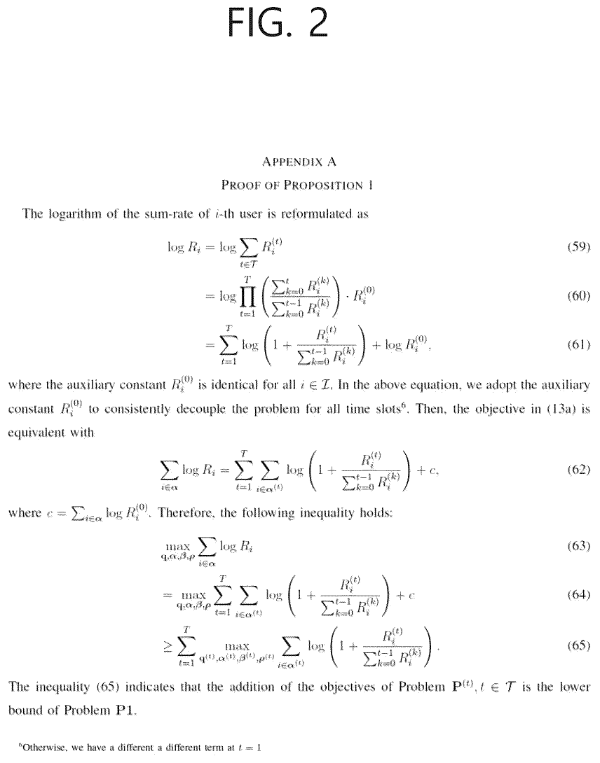

FIG. 2 is a diagram illustrating Appendix A used in an embodiment of the present disclosure.

Appendix A is shown as FIG. 2.

Next, the n-step lookahead problem will be described. By extending the step lookahead problem, the problem of simultaneously considering an n number of blocks may be defined as in Equation 19 below:

$$\begin{matrix}[ Equation 19 ] & \\ {P}_{n}^{( k )} : {max}_{{q}^{( t )} ∈ 𝒮 ( {q}^{( t - 1 )} ) , i ∈ {𝒯}_{n}^{( t )}} {\sum }_{i ∈ {𝒯}_{s}^{( k )}} f ( {q}^{( t )} ) , & ( 19 )\end{matrix}$$

$$where {𝒯}_{n}^{( k )} = \{ t ∈ 𝒯 ⋃ [ 1 + ( k - 1 ) n , kn ] \} .$$

When a sufficiently large constant K is set to satisfy

$${⋃}_{k = 1}^{K} {𝒯}_{n}^{( k )} = 𝒯 ,$$

the inequality as in Equation 20 below holds:

$$\begin{matrix}[ Equation 20 ] & \\ {max}_{q , α , β , ρ} {\sum }_{i ∈ α} log {R}_{i} \geq {\sum }_{k = 1}^{K} {max}_{{q}^{( t )} ∈ 𝒮 ( {q}^{( t - 1 )} ) , i ∈ {𝒯}_{α}^{( t )}} {\sum }_{i ∈ {𝒯}_{b}^{( k )}} f ( {q}^{( t )} ) , & ( 20 )\end{matrix}$$

In conclusion, an embodiment of the present disclosure may find a local optimal solution to the original problem by optimizing Pₙ^{(k)} K times instead of solving the optimization problem P1.

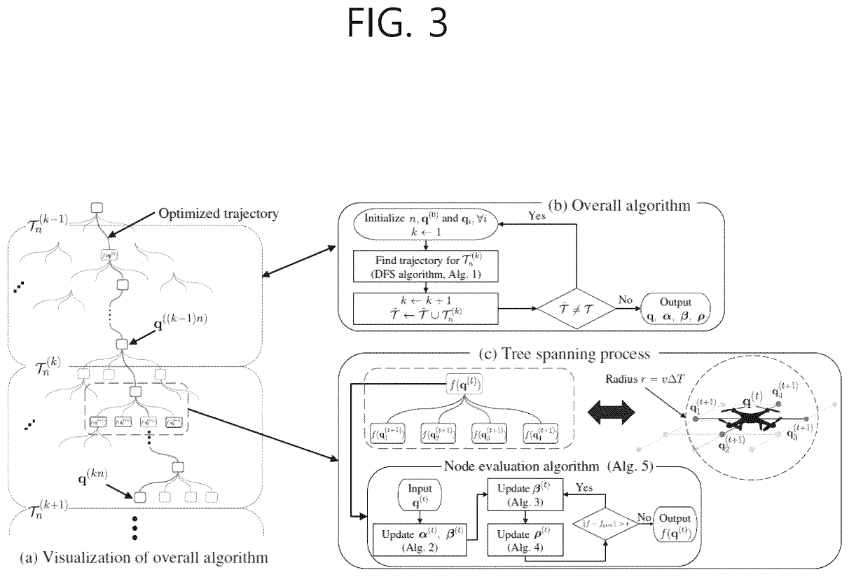

FIG. 3 is a schematic diagram illustrating an overall algorithm according to an embodiment of the present disclosure.

As illustrated in FIG. 3, the visualization of an overall algorithm shown in (a) and the overall algorithm shown in (b) are conceptually the same. The overall algorithm uses a tree spanning algorithm shown in (c) at the initial location to make the n-step lookahead problem into a shape in which each node is extended in the form of a tree as in (a). For each n-step lookahead problem, an optimal trajectory may be obtained using depth-first search. The overall algorithm may solve the n-step lookahead problem by using (c) again at the last node of the previously obtained trajectory.

The tree spanning algorithm shown in (c) will be described. When a problem is reconstructed to consider only one time slot and when the algorithm for optimizing the UA, RA, and PC variables at a given location is substituted to the optimal UA, RA, and PC variables, the tree spanning algorithm may be expressed as a function that outputs the value of an objective function. Algorithm 2 (Alg. 2), which outputs f(q), consists of sub-algorithms 3, 4, and 5 (Alg. 3, 4, 5), and is configured in the form of optimizing the RA and PC variables alternately after initializing the UA and RA variables with Algorithm 3 (Alg. 3).

The algorithm is terminated when f(q) is no longer improved even after alternately optimizing the RA and PC variables.

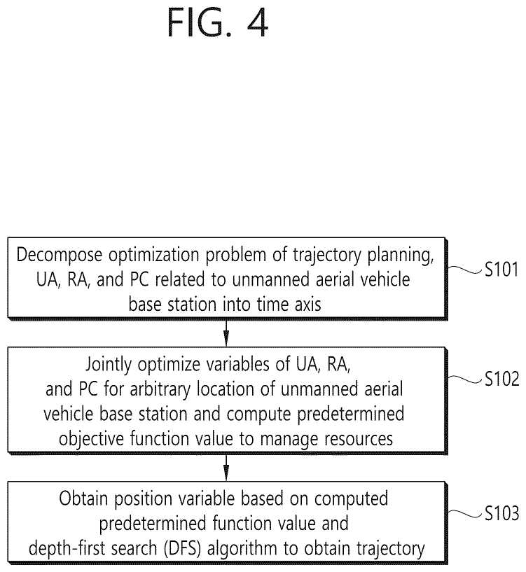

FIG. 4 is a flow diagram illustrating a tree-search based trajectory planning and resource management method of an unmanned aerial vehicle base station according to an embodiment of the present disclosure.

As illustrated in FIG. 4, in phase S101, a trajectory planning and resource management apparatus according to an embodiment of the present disclosure decomposes the optimization problem of the trajectory planning, UA, RA, and PC related to an unmanned aerial vehicle base station into a time axis.

In phase S102, the trajectory planning and resource management apparatus jointly optimizes variables of the UA, RA, and PC for an arbitrary location of an unmanned aerial vehicle base station and computes a predetermined objective function value to manage resources.

In phase S103, the trajectory planning and resource management apparatus according to an embodiment of the present disclosure obtains position variables based on the computed predetermined function value and a depth-first search (DFS) algorithm to obtain a trajectory.

In an embodiment of the present disclosure, Pₙ^{(k)} may be solved using the DFS and a resource management algorithm. The DFS is an algorithm that finds an optimal trajectory of Pₙ^{(k)} when ƒ(q^{(t)}) is given for an arbitrary location q^{(t)}. The resource management algorithm is an algorithm that obtains ƒ(q^{(t)}) by optimizing α^{(t)}, β^{(t)}, and ρ^{(t)} for a given q^{(t)}.

In other words, the two algorithms complement each other to allocate the optimal trajectory and resource of a drone base station.

The DFS algorithm will be described.

The DFS algorithm is an algorithm that obtains the position vector q^{(t)}, t∈T in a given optimization problem Pₙ^{(k)}. For a given time block set Tₙ^{(k)}, an auxiliary function

$$g : Q ↦ ℝ$$

may be introduced to compute the function ƒ(·) as shown in Equations 21 and 22 below.

$$\begin{matrix}[ Equation 21 ] & \\ \begin{matrix}g ( {q}^{( t )} \vert {𝒯}_{n}^{( k )} ) = {max}_{{q}^{( {t}^{′} + 1 )} ∈ 𝒮 ( {q}^{( {t}^{′} )} ) , {t}^{′} > i , {t}^{′} ∈ {𝒯}_{n}^{( k )}} {\sum }_{{t}^{′} > t , {t}^{′} ∈ {𝒯}_{n}^{( k )}} f ( {q}^{( {t}^{′} )} ) & ( 21 ) \\ = {max}_{{q}^{( t + 1 )} ∈ 𝒮 ( {q}^{( t )} )} f ( {q}^{( t + 1 )} ) + g ( {q}^{( t + 1 )} \vert {𝒯}_{n}^{( k )} ) , & ( 22 )\end{matrix} & \end{matrix}$$

$$\begin{matrix}[ Equation 22 ] & \\ \begin{matrix}g ( {q}^{( t )} \vert {𝒯}_{n}^{( k )} ) = {max}_{{q}^{( {t}^{′} + 1 )} ∈ 𝒮 ( {q}^{( {t}^{′} )} ) , {t}^{′} > i , {t}^{′} ∈ {𝒯}_{n}^{( k )}} {\sum }_{{t}^{′} > t , {t}^{′} ∈ {𝒯}_{n}^{( k )}} f ( {q}^{( {t}^{′} )} ) & ( 21 ) \\ = {max}_{{q}^{( t + 1 )} ∈ 𝒮 ( {q}^{( t )} )} f ( {q}^{( t + 1 )} ) + g ( {q}^{( t + 1 )} \vert {𝒯}_{n}^{( k )} ) . & ( 22 )\end{matrix} & \end{matrix}$$

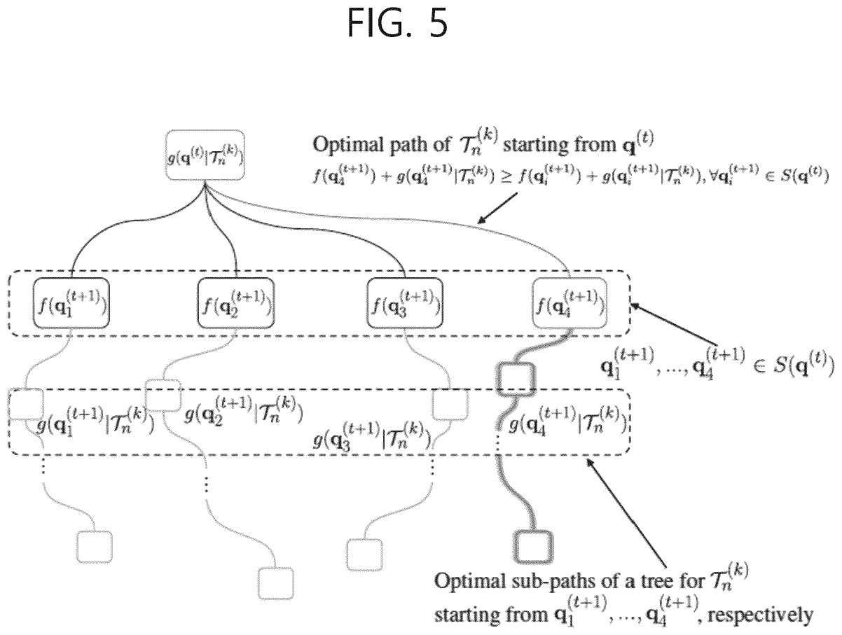

FIG. 5 is a diagram illustrating a relationship between ƒ(·) and (·).

The auxiliary function g(·) may be recursively implemented using the DFS algorithm.

Hereinafter, algorithms 1 to 5 will be described.

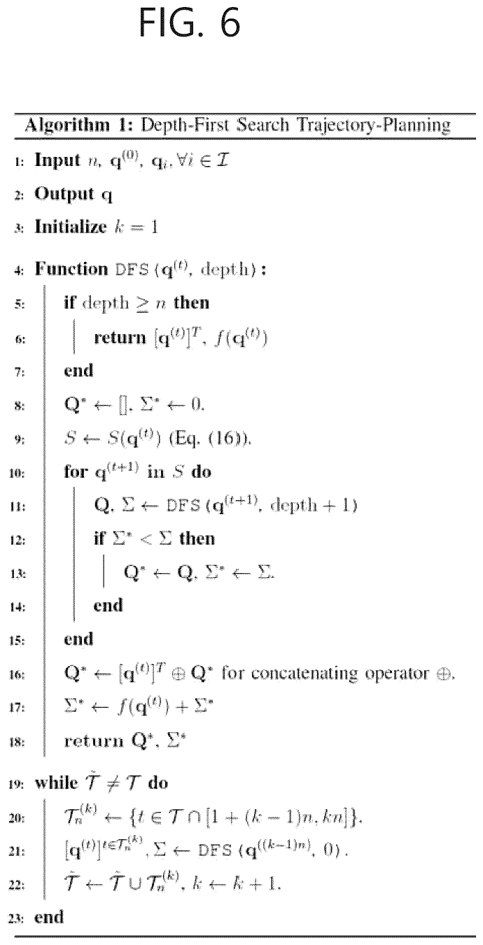

FIG. 6 is a diagram illustrating algorithm 1 according to an embodiment of the present disclosure.

As illustrated in FIG. 6, algorithm 1 is configured of a DFS function that operates recursively and a loop that circulates through the DFS function. The DFS function may solve the n-step lookahead problem. The n-step lookahead problem represents the square portion drawn by each green dotted line in (a) illustrated in FIG. 3.

Algorithm 1 performs the DFS function several times, outputs a trajectory when the total time length is satisfied, and terminates the algorithm.

The resource optimization algorithm will be described.

The resource optimization algorithm optimizes α^{(t)}, β^{(t)}, and ρ^{(t)} for a given q^{(t)} to obtain ƒ(q^{(t)}). ƒ(q^{(t)}) is a function that almost preserves convexity, but is solved using successive convex optimization, which is often used for optimizing communication resources, due to the large parameter spaces. In other words, the resource optimization algorithm determines an initial α^{(t)} as a sub-algorithm for obtaining α^{(t)} and β^{(t)}, and then computes ƒ(q^{(t)}) by iteratively optimizing β^{(t)} and ρ^{(t)}.

Optimization is obtained by searching for a Karush-Kuhn-Tucker (KKT) condition of the Lagrangian dual problem in (18).

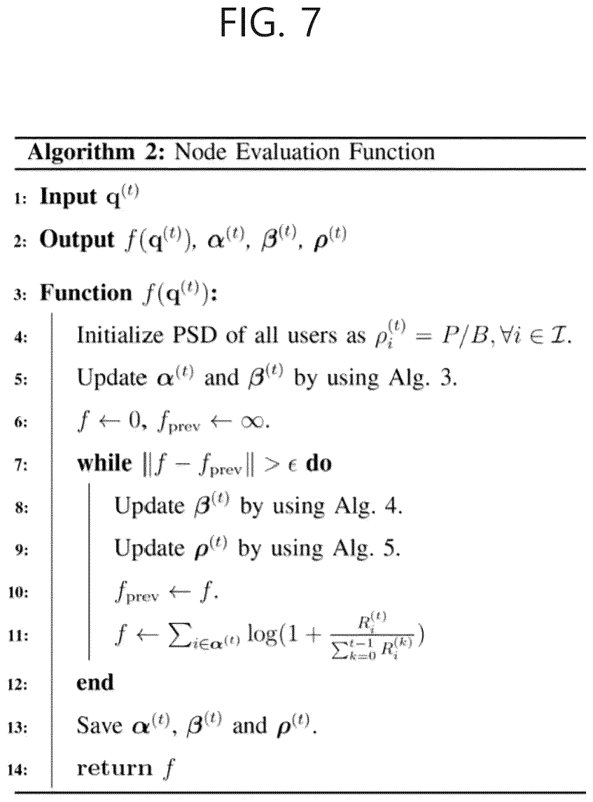

FIG. 7 is a diagram illustrating resource optimization algorithm 2 according to an embodiment of the present disclosure.

As illustrated in FIG. 7, resource optimization algorithm 2 represents a resource optimization algorithm that computes ƒ(q^{(t)}).

Algorithm 2 is an algorithm shaped in (c) of FIG. 3. Algorithm 2 is an algorithm that utilizes sub-algorithms 3, 4, and 5 to output the optimal values of ƒ(q^{(t)}), UA, RA, and PC variables when a location is given.

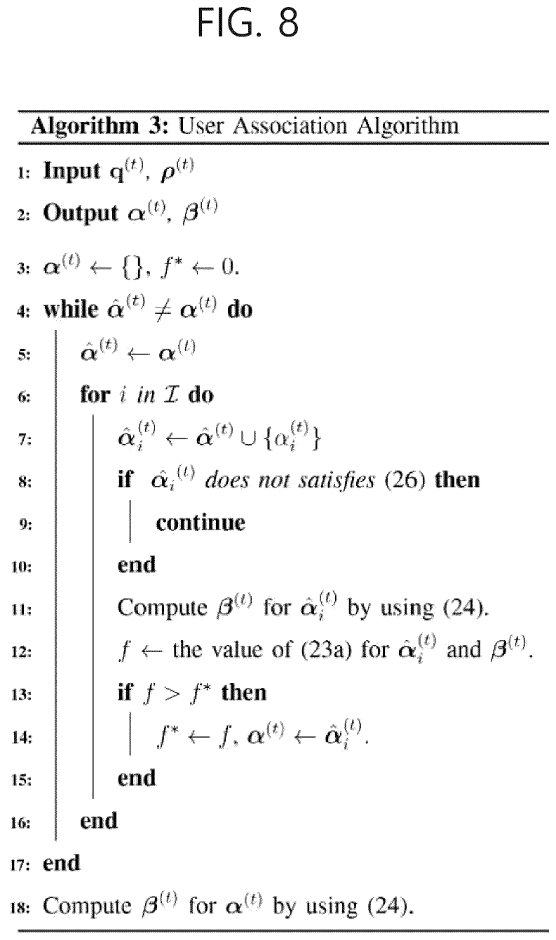

FIGS. 8 to 10 are drawings illustrating algorithms 3 to 5 according to an embodiment of the present disclosure.

As illustrated in FIG. 8, when the UA and RA variables are initialized with algorithm 3, then the RA and PC variables may be alternately optimized. In this connection, algorithm 3, which is a sub-algorithm, is illustrated in FIG. 8.

(24) of algorithm 3 is the same as in Equation 24 below:

$$\begin{matrix}[ Equation 24 ] & \\ {β}_{i}^{( t )} = \{ \begin{matrix}max ( \frac{{r}_{i}}{{e}_{i}^{( t )}} , \frac{1}{λ} - \frac{{\sum }_{k = 0}^{t - 1} {R}_{i}^{( k )}}{{e}_{i}^{( t )}} ) & if {α}_{i}^{( t )} = {d}_{i}^{( t )} = 1 , \\ 0 & otherwise ,\end{matrix} & \end{matrix}$$

(26) of algorithm 3 is the same as in Equation 26 below:

$$\begin{matrix}[ Equation 26 ] & \\ {\sum }_{i ∈ {α}^{( t )}} \frac{{r}_{i}}{{e}_{i}^{( t )}} \leq B . & \end{matrix}$$

As such, algorithm 3 is an algorithm that optimizes the UA and RA variables when the position variables and the PC variables are given. Algorithm 3 utilizes a generalized water-filling technique with quality of service (QOS) constraints that jointly optimize user association variables and frequency allocation variables to output the UA and RA variables close to the optimum.

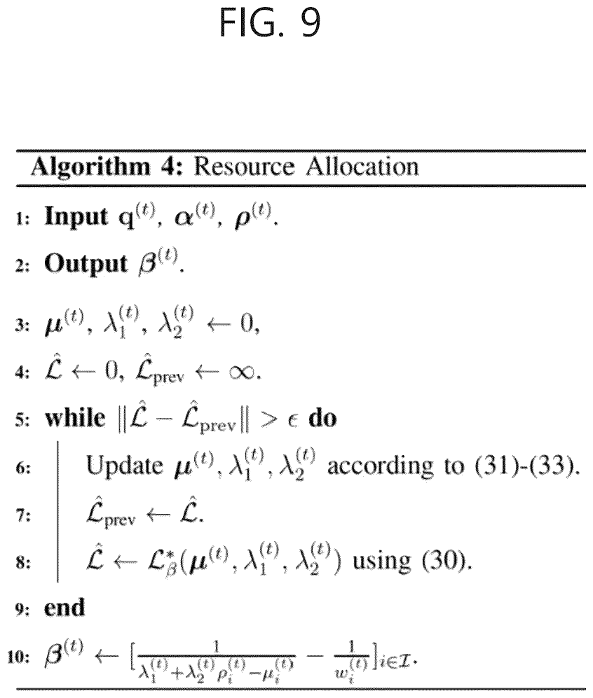

FIG. 9 illustrates algorithm 4 according to an embodiment of the present disclosure.

(30)-(33) of algorithm 4 are the same as in Equations 30 to 33 below:

$$\begin{matrix}[ Equation 30 ] & \\ {ℒ}_{β}^{*} ( {μ}^{( t )} , {λ}_{1}^{( t )} , {λ}_{2}^{( t )} ) = - {\sum }_{i ∈ {α}^{( t )}} {α}_{i}^{( t )} - {\sum }_{i ∈ {α}^{( t )}} log ( {λ}_{1}^{( t )} + {λ}_{2}^{( t )} {ρ}_{i}^{( t )} - {μ}_{i}^{( t )} ) - {\sum }_{i ∈ {α}^{( t )}} {μ}_{i}^{( t )} ( \frac{1}{{w}_{i}^{( t )}} + \frac{{α}_{i}^{( t )} {r}_{i}}{{e}_{i}^{( t )}} ) + {λ}_{1}^{( t )} ( {\sum }_{i ∈ {α}^{( t )}} \frac{1}{{w}_{i}^{( t )}} + B ) + {λ}_{2}^{( t )} ( {\sum }_{i ∈ {α}^{( t )}} \frac{{ρ}_{i}^{( t )}}{{w}_{i}^{( t )}} + P ) . & \end{matrix}$$

$$\begin{matrix}[ Equation 31 ] & \\ {μ}_{i}^{( t )} ← {μ}_{i}^{( t )} - γ ( \frac{1}{{o}_{i}^{( t )}} - \frac{1}{{w}_{i}^{( t )}} - \frac{{α}_{i}^{( t )} {r}_{i}}{{e}_{i}^{( t )}} ) , & \end{matrix}$$

$$\begin{matrix}[ Equation 32 ] & \\ {λ}_{1}^{( t )} ← {λ}_{1}^{( t )} - γ ( - {\sum }_{i ∈ {α}^{( t )}} \frac{1}{{o}_{i}^{( t )}} + B + {\sum }_{i ∈ {α}^{( t )}} \frac{1}{{w}_{i}^{( t )}} ) , & \end{matrix}$$

$$\begin{matrix}[ Equation 33 ] & \\ {λ}_{2}^{( t )} ← {λ}_{2}^{( t )} - γ ( - {\sum }_{i ∈ {α}^{( t )}} \frac{{ρ}_{i}^{( t )}}{{o}_{i}^{( t )}} + P + {\sum }_{i ∈ {α}^{( t )}} \frac{{ρ}_{i}^{( t )}}{{w}_{i}^{( t )}} ) , & \end{matrix}$$

Algorithm 4 according to an embodiment of the present disclosure is an algorithm that optimizes the RA variables when the location, UA, and PC variables are given. After being converted into a Lagrangian dual problem, algorithm 4 may obtain optimal Lagrangian coefficients using a gradient descent technique. Algorithm 4 may obtain the RA variables by combining the obtained Lagrangian coefficients.

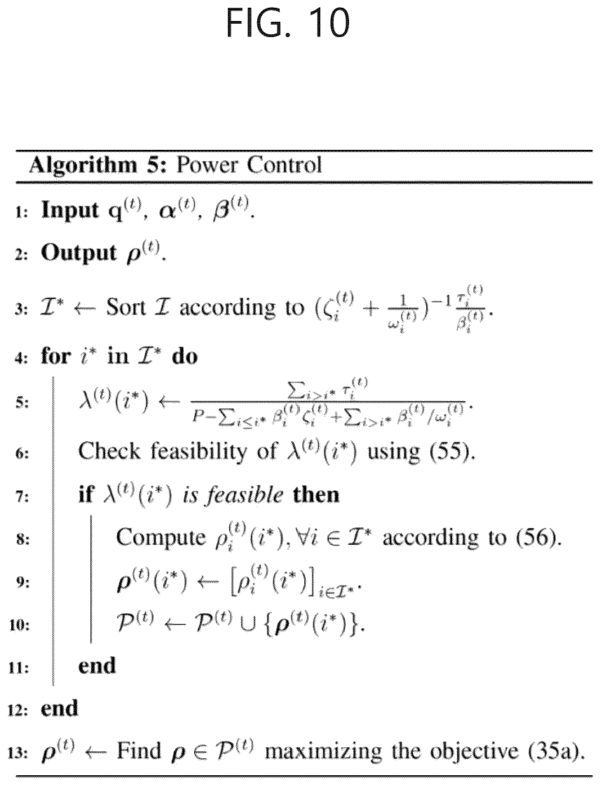

FIG. 10 illustrates algorithm 5 according to an embodiment of the present disclosure.

(35a) of algorithm 5 is the same as in Equation 35 below:

$$\begin{matrix}[ Equation 35 ] & \\ {max}_{{ρ}^{( t )}} {\sum }_{i ∈ {α}^{( t )}} log ( 1 + \frac{{R}_{i}^{( t )}}{{\sum }_{k = 0}^{t - 1} {R}_{i}^{( k )}} ) & ( 35 a )\end{matrix}$$

$$s . t . {ρ}_{i}^{( t )} \geq 0 , ∀ i , \qquad ( 35 b )$$

$${\sum }_{i ∈ {α}^{( t )}} {ρ}_{i}^{( t )} {β}_{i}^{( t )} \leq P , \qquad ( 35 c )$$

$${R}_{i}^{( t )} \geq {α}_{i}^{( t )} {r}_{i} , ∀ i . \qquad ( 35 d )$$

(55) and (56) of algorithm 5 are the same as in Equations 55 and 56 below:

$$\begin{matrix}[ Equation 55 ] & \\ {( {ζ}_{i}^{( t )} + \frac{1}{{w}_{{i}^{*}}^{( t )}} )}^{- 1} \frac{{τ}_{{i}^{*}}^{( t )}}{{β}_{{i}^{*}}^{( t )}} \leq {λ}^{( t )} ( {i}^{*} ) \leq {( {ζ}_{1 + {i}^{*}}^{( t )} + \frac{1}{{w}_{1 + {i}^{*}}^{( t )}} )}^{- 1} \frac{{τ}_{1 + {i}^{*}}^{( t )}}{{β}_{1 + {i}^{*}}^{( t )}} . & \end{matrix}$$

$$\begin{matrix}[ Equation 56 ] & \\ {ρ}_{i}^{( t )} ( {i}^{*} ) = \{ \begin{matrix}\frac{{τ}_{i}^{( t )}}{{β}_{i}^{( t )} {λ}^{( t )} ( {i}^{*} )} - \frac{1}{{w}_{i}^{( t )}} , & if i > {i}^{*} \\ {ζ}_{i}^{( t )} , & if i \leq {i}^{*}\end{matrix} , & \end{matrix}$$

Algorithm 5 according to an embodiment of the present disclosure is an algorithm that optimizes the PC variables when the location, UA, and RA variables are given. After being converted into a Lagrangian dual problem, algorithm 5 may obtain a Lagrangian coefficient that satisfies a KKT condition. In addition, algorithm 5 may select control variables showing the highest predetermined objective function f(q) value among the Lagrangian coefficients satisfying the obtained KKT condition.

An embodiment of the present disclosure and an embodiment of a comparison group will be described.

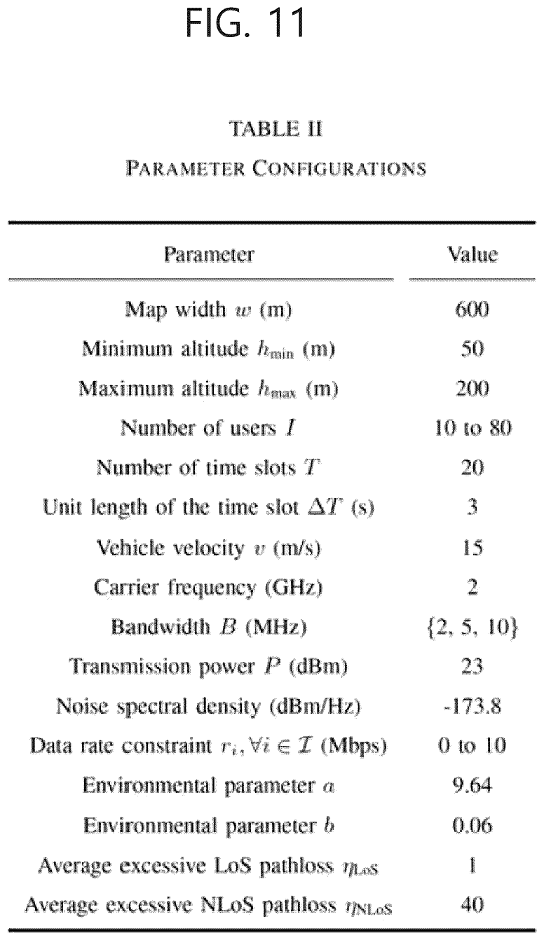

FIG. 11 is a table illustrating a parameter configuration table set in an embodiment.

Embodiments were set as shown in the table illustrated in FIG. 11 in consideration of the 3GPP standard and the latest research trends. As a comparison group, the following three cases were set.
i) The case of using the resource optimization method according to an embodiment of the present disclosure but using the same in the center of a service area without trajectory planning (Fixed-TP)
ii) The case of using the resource optimization method according to an embodiment of the present disclosure but flying in a circumferential trajectory (Circular-TP)
iii) The case of using trajectory planning and resource optimization techniques presented in the thesis “Trajectory optimization and resource allocation for OFDMA UAV relay networks” submitted to “IEEE Transactions on Wireless Communications” (OFMDA)

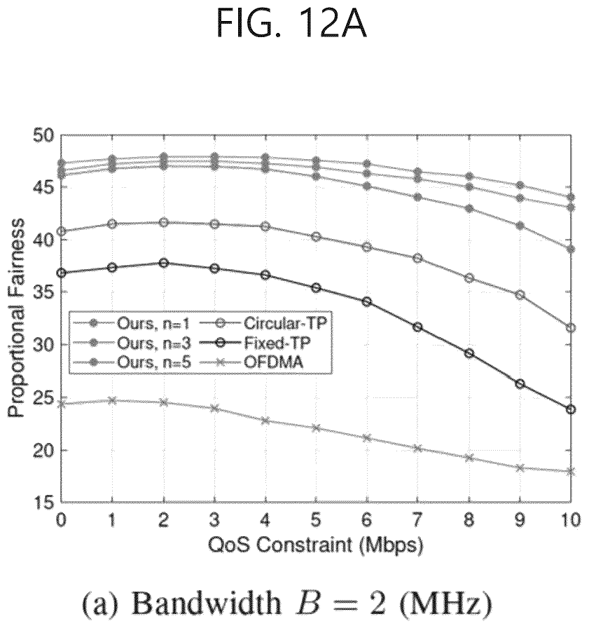

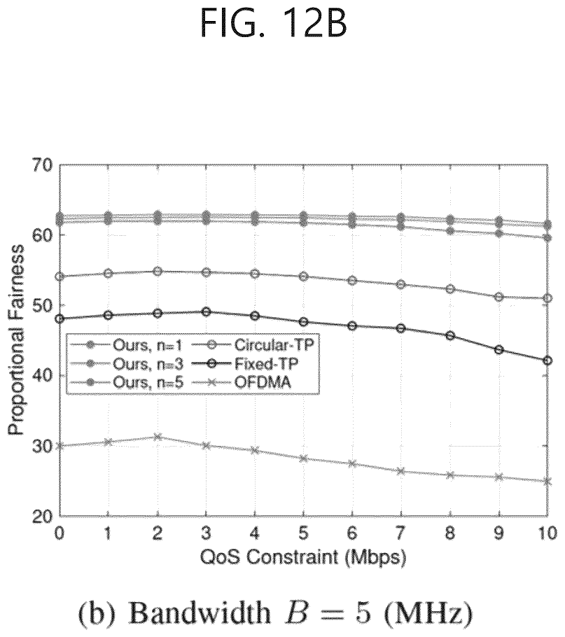

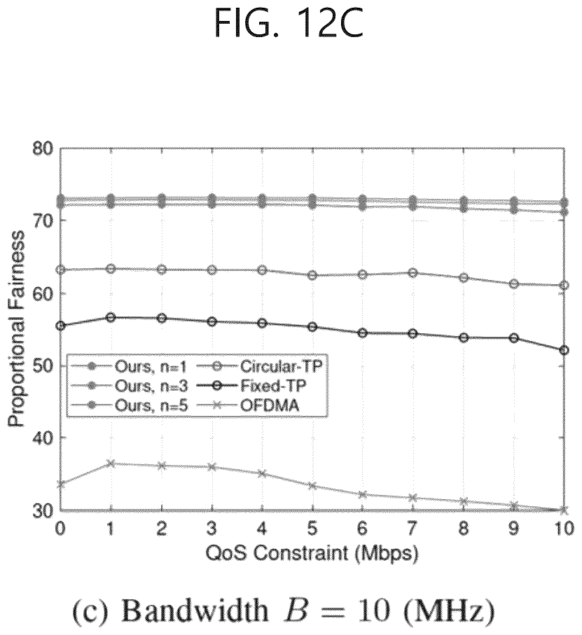

Hereinafter, in FIGS. 12 to 14, an embodiment of the present disclosure is indicated by “Ours, n=1”, “Ours, n=3”, and “Ours, n=5”, and the comparison group is indicated by “Fixed-TP,” “Circular-TP,” and “OFMDA.”

FIG. 12A to FIG. 12C are graphs measuring proportional fairness for various QoS constraints according to Embodiment 1.

FIG. 12A to FIG. 12C are graphs in which the PF is measured for various QoS constraints rᵢ. The experiment was conducted while changing the available bandwidth to 2, 5, and 10 MHz.

As illustrated in FIG. 12A to FIG. 12C, a trajectory planning and resource management method (Ours) according to an embodiment of the present disclosure showed a 95% higher PF value than the OFDMA comparison group. In addition, as the available bandwidth increases, it is understood that compared to other comparison groups, the trajectory planning and resource management (Ours) according to an embodiment of the present disclosure hardly decreases even when the QoS constraint increases. In the 2 MHz bandwidth, the difference between the highest and lowest values for each technology of 17% (Ours, n=1), 9% (Ours, n=3), 8% (Ours, n=5), 25% (circular-TP), 37% (fixed-TP), and 27% (OFDMA) was shown.

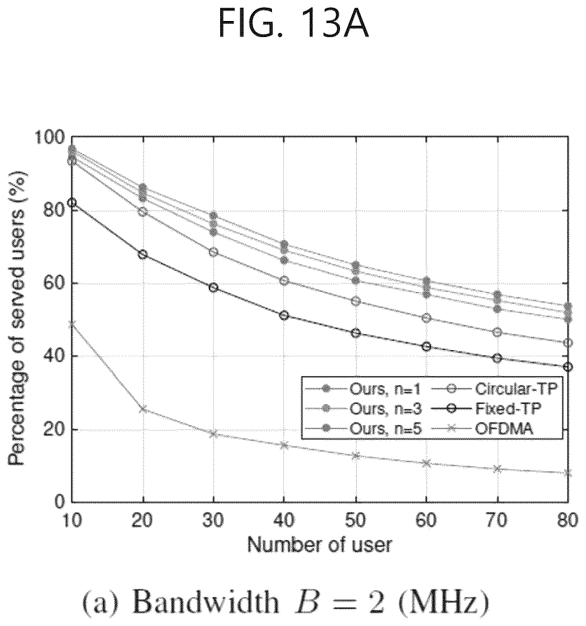

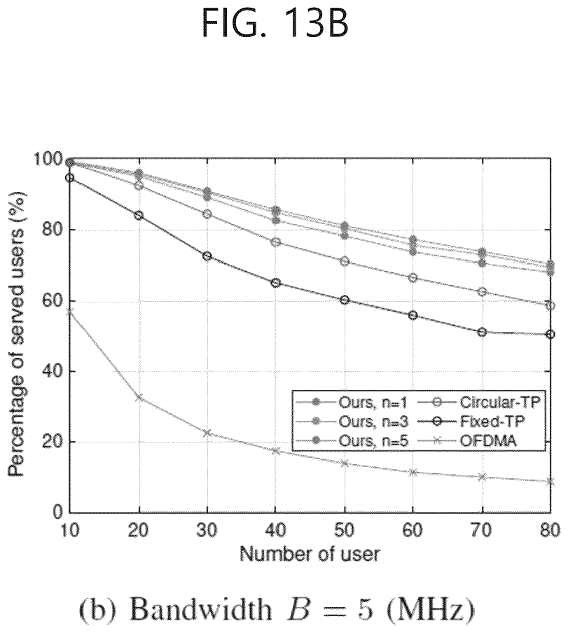

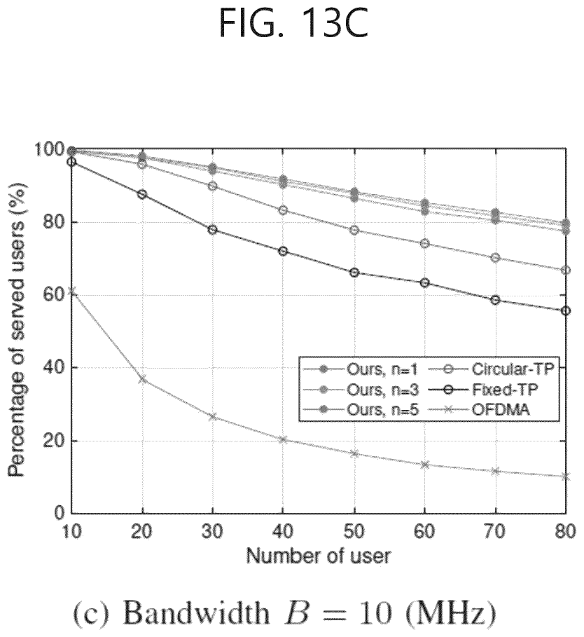

FIG. 13A to FIG. 13C are graphs measuring a user ratio served for various QoS constraints according to Embodiment 2.

FIG. 13A to FIG. 13C are graphs measuring the ratio of users receiving services for various QoS constraints rᵢ. The experiment was conducted while changing the available bandwidth to 2, 5, and 10 MHz. In the 2 MHz bandwidth, the trajectory planning and resource management method (Ours) according to an embodiment of the present disclosure might serve 51% p more users than OFDMA.

In addition, in the trajectory planning and resource management method (Ours) according to an embodiment of the present disclosure, it was identified that as the available bandwidth increased, the ratio of users who had been serviced gradually increased to close to 100%, while the OFDMA comparison group did not.

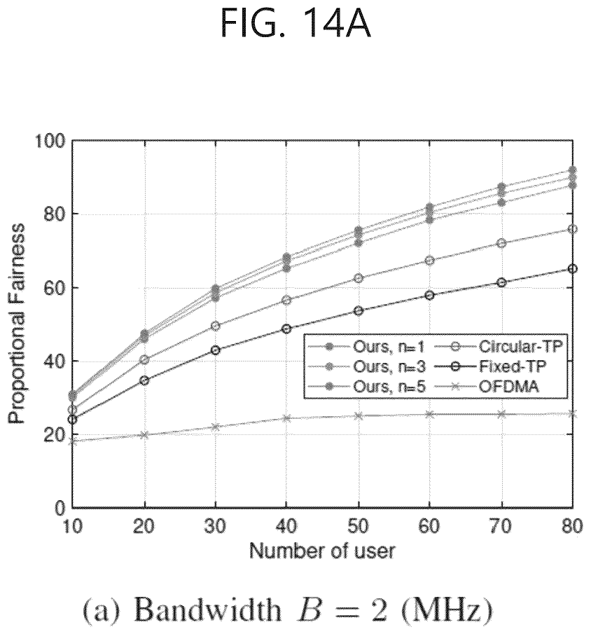

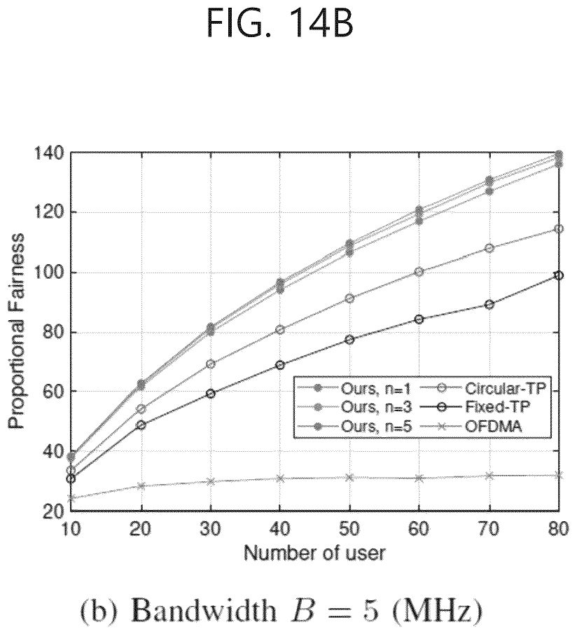

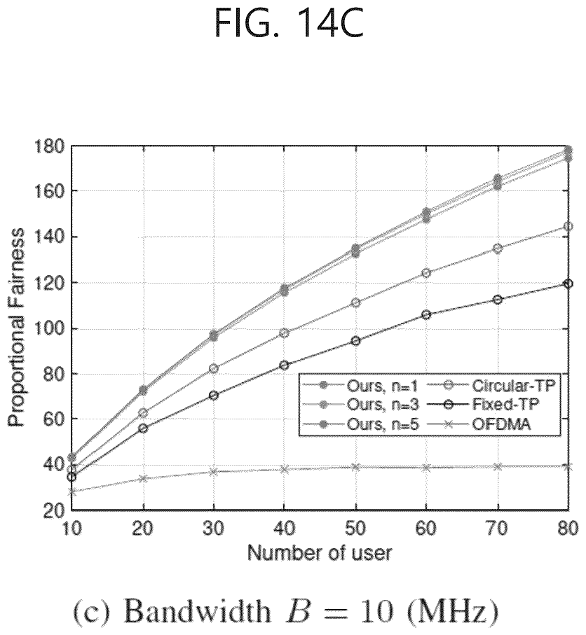

FIG. 14A to FIG. 14C are graphs measuring proportional fairness (PF) for various QoS constraints according to Embodiment 3.

FIG. 14A to FIG. 14C are graphs measuring the PF for various QoS constraints rᵢ The experiment was conducted while changing the available bandwidth to 2, 5, and 10 MHz.

When the total number of users increases from 10 to 80, the trajectory planning and resource management method (Ours) according to an embodiment of the present disclosure recorded a 196% high PF value, but in the case of OFDMA, the improvement was only 41%. Circular-TP and fixed-TP showed an upward ratio similar to that of the trajectory planning and resource management method (Ours) according to an embodiment of the present disclosure, but showed 20% and 40% lower PF values, respectively.

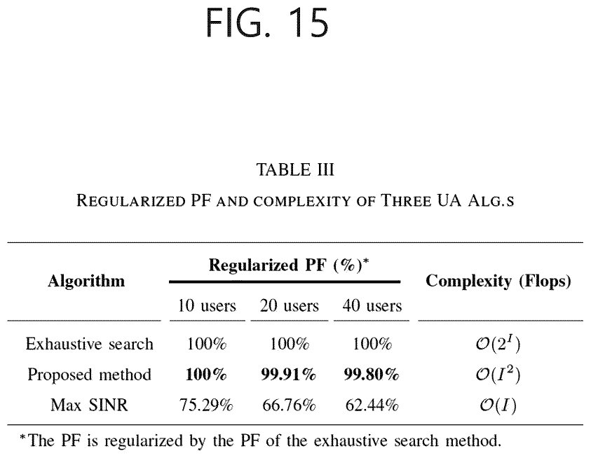

FIG. 15 is a table illustrating a normalized proportional fairness and complexity table according to Embodiment 4.

As in the table illustrated in FIG. 15, the trajectory planning and resource management method (Proposed method) according to an embodiment of the present disclosure showed almost identical performance to the full search and greatly reduced the amount of computation.

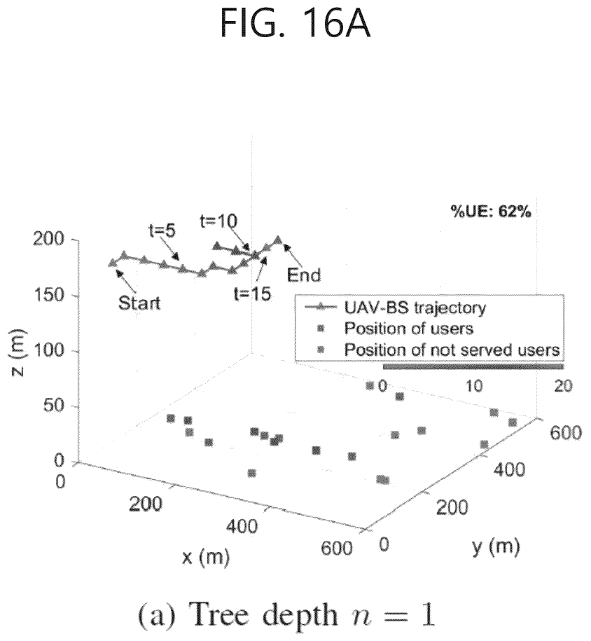

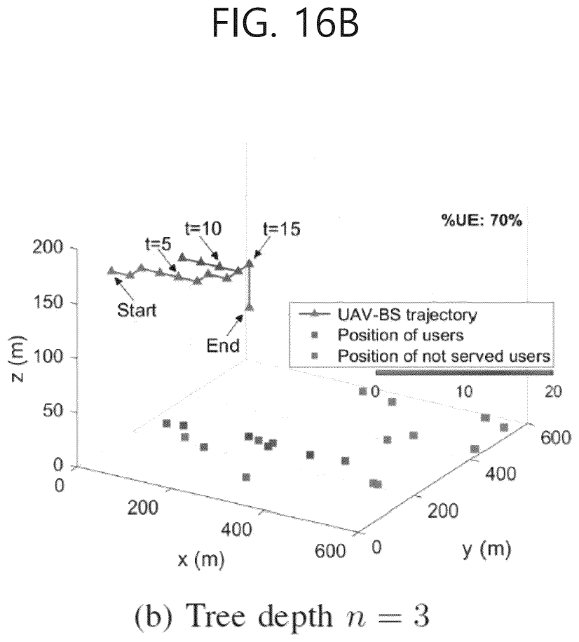

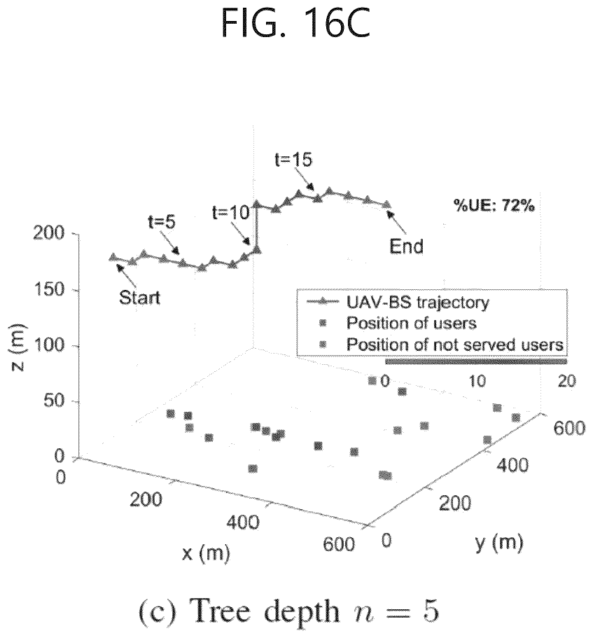

FIG. 16A to FIG. 16C are graphs illustrating a substantial trajectory of a UAV base station according to a lookahead variable according to Embodiment 5.

FIG. 16A to FIG. 16C show a substantial trajectory of the UAV base station according to the lookahead variable n. The experiment was conducted under the conditions of l=20; rᵢ=10, ∀i∈J; B=2 (MHz). Users marked in red indicate users who have not been serviced, the color of the users indicates the time when the service was first received, and the color of the trajectory to the UAV base station indicates the location of the UAV base station at each time.

As the lookahead variable n increases, it was identified that the UAV base station moves a little more distance and serves more users.

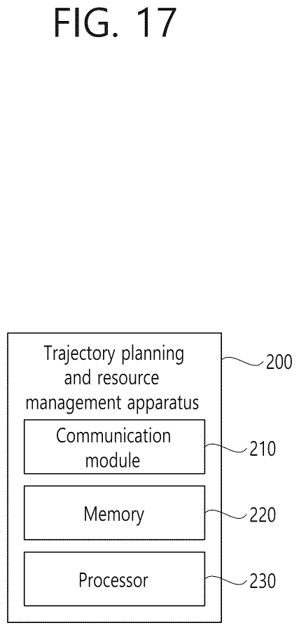

FIG. 17 is a block diagram of a tree-search based trajectory planning and resource management apparatus of an unmanned aerial vehicle base station according to an embodiment of the present disclosure.

As illustrated in FIG. 17, a tree-search based trajectory planning and resource management apparatus 200 of an unmanned aerial vehicle base station according to an embodiment of the present disclosure includes: a communication module 210; a memory 220; and a processor 230. However, not all illustrated components are essential components. The trajectory planning and resource management apparatus 200 may be implemented by more components than those illustrated, and the trajectory planning and resource management apparatus 200 may be implemented by fewer components.

Hereinafter, a detailed configuration and operation of each component of the trajectory planning and resource management apparatus 200 of FIG. 17 will be described.

The communication module 210 may communicate to provide services to one or more IoT devices or user terminals related to tree-search based trajectory planning and resource management of an unmanned aerial vehicle base station.

The memory 220 stores one or more programs related to tree-search based trajectory planning and resource management of an unmanned aerial vehicle base station.

The processor 230 executes one or more programs stored in the memory 220. The processor may: decompose an optimization problem of trajectory planning, user association (UA), resource allocation (RA), and power control (PC) related to an unmanned aerial vehicle base station into a time axis; manage resources by jointly optimizing variables of the UA, RA, and PC for an arbitrary location of the unmanned aerial vehicle base station; and obtain the trajectory planning by obtaining position variables based on the obtained predetermined function value and a depth-first search (DFS) algorithm.

According to embodiments, the processor 230 may reconstruct an optimization problem into a plurality of sub-problems through a 1-step lookahead and an n-step lookahead.

According to embodiments, the processor 230 may separate a trajectory planning problem and a resource optimization problem using a predetermined objective function.

According to embodiments, the processor 230 may optimize user association variables and frequency allocation variables when position variables and power control variables are given.

According to embodiments, the processor 230 may select optimal user association variables and frequency allocation variables using a generalized water-filling technique with quality-of-service (QOS) constraints that jointly optimizes the user association variables and the frequency allocation variable.

According to embodiments, the processor 230 may optimize the frequency allocation variables when the position variables, the user association variables, and the power control variables are given.

According to embodiments, the processor 230 may obtain optimal Lagrangian coefficients using a gradient descent technique after being converted into a Lagrangian dual problem, and select frequency allocation variables by combination of the obtained Lagrangian coefficient.

According to embodiments, the processor 230 may optimize the power control variables when the position variables, the user association variables, and the frequency allocation variables are given.

According to embodiments, the processor 230 may obtain a Lagrangian coefficient that satisfies a Karush-Kuhn-Tucker (KKT) condition after being converted into a Lagrangian dual problem, and select power control variables having the highest predetermined objective function value among the Lagrangian coefficients satisfying the KKT condition.

As such, recent advances in UAV base stations (UAV-BSs) have led to a proliferation of studies on wireless technologies for IoT networks. In the IoT networks, the UAV-BSs may utilize mobility to provide high-speed access links to widespread IoT devices.

The trajectory planning and resource management method according to an embodiment of the present disclosure may optimize trajectory planning, user association (UA), resource allocation (RA), and power control (PC) in order to maximize the proportional fairness (PF) under users' communication requests and quality-of-service (QOS) constraints.

Herein, the co-optimization problem of the trajectory planning, UA, RA and PC for the UAV-BS is generally a mixed-integer NP-hard problem with severe non-convexity. The trajectory planning and resource management method according to an embodiment of the present disclosure may reconstruct the proposed problem into a series of tree search problems to solve the problem.

The trajectory planning and resource management method according to an embodiment of the present disclosure may be configured into three parts: i) time axis decomposition of the proposed problem, ii) depth-first search (DFS)-based trajectory planning, and iii) resource management that jointly optimizes UA, RA and PC variables.

The trajectory planning and resource management method according to an embodiment of the present disclosure first divides a proposed problem into a series of sub-problems and then finds a near-optimal solution of the sub-problems to mitigate the non-convexity of the proposed problem.

Next, in the trajectory planning and resource management method according to an embodiment of the present disclosure, an optimal trajectory for each sub-problem may be found using a DFS-based trajectory planning algorithm.

In this connection, in the trajectory planning and resource management method according to an embodiment of the present disclosure, the DFS-based algorithm may optimize UA, RA, and PC variables for all feasible trajectories in advance in order to determine an optimal trajectory. Accordingly, in order to jointly optimize the UA, RA, and PC variables, the trajectory planning and resource management method according to an embodiment of the present disclosure may use a resource management system having low computational complexity and close to optimal in the third part. The resource optimization algorithm achieved 99% performance of full search. The amount of computation was greatly reduced for an I number of devices.

The trajectory planning and resource management method according to an embodiment of the present disclosure has been shown to improve PF by 95% and provide services to more users by 40% p compared to the world's highest level as a result of experiments. The trajectory planning and resource management method according to an embodiment of the present disclosure may first solve the problem by using a tree search algorithm for the UAV-BS trajectory planning problem.

According to an embodiment of the present disclosure, various embodiments described above may be implemented as software including instructions stored in a machine-readable storage media which is readable by a machine (for example, a computer). The device may include an electronic device (for example, electronic device (A)) according to the disclosed embodiments, as a device which calls the stored instructions from the storage media and which is operable according to the called instructions. When the instructions are executed by a processor, the processor may directly perform a function corresponding to an instruction or by using other components under the control of the processor. The instructions may include code generated or executed by a compiler or an interpreter. The machine-readable storage media may be provided in a form of a non-transitory storage media. The term “non-transitory” means that the storage media does not include a signal and is tangible, but does not distinguish whether data is stored semi-permanently or temporarily in the storage media.

In addition, according to an embodiment of the present disclosure, the methods according to various embodiments described above may be provided as a part of a computer program product. The computer program product may be traded between a seller and a buyer as commodities. The computer program product may be distributed in a form of the machine-readable storage media (for example, compact disc read only memory (CD-ROM)) or distributed online through an application store (for example, PlayStore™). In the case of the online distribution, at least a portion of the computer program product may be at least temporarily stored or provisionally generated on the storage media, such as a manufacturer's server, an application store's server, or a memory in a relay server.

In addition, according to an embodiment of the present disclosure, the aforementioned various embodiments may be implemented in a recording medium that may be read by a computer or a device similar to a computer, using software, hardware, or a combination thereof. In some cases, the embodiments described in this specification may be implemented by a processor itself. According to implementation by software, the embodiments such as processes and functions described in this disclosure may be implemented by separate software modules. Each of the software modules may perform one or more functions and operations described in this specification.

Computer instructions for performing the processing operations of the apparatus according to various embodiments described above may be stored in a non-transitory computer-readable medium. The computer instructions stored in the non-transitory computer-readable medium cause a particular apparatus to perform the processing operations on the apparatus according to the various embodiments described above when executed by the processor of the particular apparatus. A non-transitory computer readable medium is a medium that semi-permanently stores data and is readable by an apparatus, not a medium that stores data for a short moment, such as a register, cache, or memory. Specific examples of non-transitory computer-readable media include CD, DVD, hard disk, Blu-ray disk, USB, memory card, ROM, or the like.

Each of the elements (for example, a module or a program) according to various embodiments described above may be configured of a single entity or a plurality of entities. Some sub-elements of the abovementioned sub-elements may be omitted, or other sub-elements may be further included in various embodiments. Alternatively or additionally, some elements (for example, a module or a program) may be integrated into one entity to perform the same or similar functions performed by each respective element prior to integration. Operations performed by a module, program, or other element, in accordance with various embodiments, may be performed sequentially, in a parallel, repetitive, or heuristically manner, at least some of the operations may be executed in a different order or omitted, or other operations may be added.

Hereinbefore, although the preferred embodiments of the present disclosure have been disclosed for illustrative purposes, the present disclosure is not limited to the specific exemplary embodiments and various modifications may be made by those skilled in the technical field to which the present disclosure pertains without departing from the scope of the present disclosure claimed in the claims, and such modifications should not be individually understood from technical concepts or prospects of the present disclosure.

### DESCRIPTION OF REFERENCE NUMERALS

200: Trajectory planning and resource management apparatus
210: Communication module
220: Memory
230: Processor

What is claimed is:

1. A tree-search based trajectory planning and resource management method of an unmanned aerial vehicle base station performed by a trajectory planning and resource management apparatus, the method including:
decomposing an optimization problem of trajectory planning, user association (UA), resource allocation (RA), and power control (PC) related to the unmanned aerial vehicle base station into a time axis;
managing resources by jointly optimizing variables of the UA, RA, and PC for an arbitrary location of the unmanned aerial vehicle base station and computing a predetermined objective function value; and
obtaining the trajectory planning by obtaining position variables based on the computed predetermined function value and a depth-first search (DFS) algorithm.

2. The method of claim 1, wherein, in the decomposition of the optimization problem into the time axis, the optimization problem is reconstructed into a plurality of sub-problems through a 1-step lookahead and an n-step lookahead.

3. The method of claim 1, wherein, in the decomposition of the optimization problem into the time axis, a trajectory planning problem and a resource optimization problem are separated using a predetermined objective function.

4. The method of claim 1, wherein, in the management of the resources, when position variables and power control variables are given, user association variables and frequency allocation variables are optimized.

5. The method of claim 4, wherein, in the management of the resources, optimal user association variables and frequency allocation variables are selected using a generalized water-filling technique with quality-of-service (QOS) constraints that jointly optimizes the user association variables and the frequency allocation variable.

6. The method of claim 4, wherein, in the management of the resources, when the position variables, the user association variables, and the power control variables are given, the frequency allocation variables are optimized.

7. The method of claim 6, wherein, in the management of the resources, after being converted into a Lagrangian dual problem, optimal Lagrangian coefficients is obtained using a gradient descent technique, and the frequency allocation variables are selected by combination of the obtained Lagrangian coefficient.

8. The method of claim 4, wherein, in the management of the resources, when the position variables, the user association variables, and the frequency allocation variables are given, the power control variables are optimized.

9. The method of claim 8, wherein, in the management of the resources, after being converted into a Lagrangian dual problem, a Lagrangian coefficient that satisfies a Karush-Kuhn-Tucker (KKT) condition is obtained, and power control variables having the highest predetermined objective function value among the Lagrangian coefficients satisfying the KKT condition is selected.

10. A tree-search based trajectory planning and resource management apparatus of an unmanned aerial vehicle base station, the apparatus including:
a communication module;
a memory storing one or more programs; and
a processor executing the stored one or more programs,
the processor being configured to:
decompose an optimization problem of trajectory planning, user association (UA), resource allocation (RA), and power control (PC) related to an unmanned aerial vehicle base station into a time axis;
manage resources by jointly optimizing variables of the UA, RA, and PC for an arbitrary location of the unmanned aerial vehicle base station and computing a predetermined objective function value; and
obtain the trajectory planning by obtaining position variables based on the computed predetermined function value and a depth-first search (DFS) algorithm.

11. The apparatus of claim 10, wherein the processor reconstructs the optimization problem into a plurality of sub-problems through a 1-step lookahead and an n-step lookahead.

12. The apparatus of claim 10, wherein the processor separates a trajectory planning problem and a resource optimization problem using a predetermined objective function.

13. The apparatus of claim 10, wherein, when position variables and power control variables are given, the processor optimizes user association variables and frequency allocation variables.

14. The apparatus of claim 10, wherein the processor selects optimal user association variables and frequency allocation variables using a generalized water-filling technique with quality-of-service (QOS) constraints that jointly optimizes the user association variables and the frequency allocation variable.

15. The apparatus of claim 13, wherein, when the position variables, the user association variables, and the power control variables are given, the processor optimizes the frequency allocation variable.

16. The apparatus of claim 15, wherein, after being converted into a Lagrangian dual problem, the processor obtains optimal Lagrangian coefficients using a gradient descent technique, and selects frequency allocation variables by combination of the obtained Lagrangian coefficient.

17. The apparatus of claim 13, wherein, when the position variables, the user association variables, and the frequency allocation variables are given, the processor optimizes the power control variable.

18. The apparatus of claim 17, wherein, after being converted into a Lagrangian dual problem, the processor obtains a Lagrangian coefficient that satisfies a Karush-Kuhn-Tucker (KKT) condition, and selects power control variables having the highest predetermined objective function value among the Lagrangian coefficients satisfying the KKT condition.
